(19) United States
(12) Patent Application Publication
(10) Pub. No.: US 2014/0049107 A1
(43) Pub. Date: Feb. 20, 2014

(54) Intelligent Lighting and Electrical System

(71) Applicant: Keith Marx, Richardson, TX (US)

(72) Inventor: Keith Marx, Richardson, TX (US)

(21) Appl. No.: 13/968,896

(22) Filed: Aug. 16, 2013

Related U.S. Application Data
(60) Provisional application No. 61/742,647, filed on Aug. 16, 2012.

(51) Int. Cl. H02J 4/00

(52) U.S. Cl. CPC H02J 4/00
USPC 307/31; 29/825

(57) ABSTRACT

An intelligent electrical system is provided, including one or more of an intelligent controller, and intelligent electrical fixture and an intelligent port. Each component may have one or more continuously powered electrical devices and one or more switched electrical devices. Control signals may be delivered from the controller to the fixtures and ports, as well as to other controllers, in order to control power supplied to the components, and to control operation of the components and the devices within the components. Physical switching, and control, of power to fixtures and ports occurs locally at the components rather than at a remote power switch.

### CROSS-REFERENCE TO RELATED APPLICATION(S) AND CLAIM OF PRIORITY

The present application is related to U.S. Provisional Patent Application No. 61/742,647, filed Aug. 16, 2012, entitled “Distributed Intelligent Lighting System.” The present application hereby claims priority under 35 U.S.C. §119(e) to U.S. Provisional Patent Application No. 61/742,647.

### TECHNICAL FIELD

Various embodiments of the invention relate generally to lighting systems and, more particularly, to an intelligent lighting system that will support constant power to electrical fixtures having multiple electrical device.

### BACKGROUND

Typical legacy lighting systems have changed little over many years. Typical systems, such as those for residential and commercial structures, are driven by the main power supply delivered to those structures from the utility power grid. In the United States, this power supply is delivered at 60 hertz and 110 volts, or 60 Hz/110V. Typically, electrical fixtures within the structure are powered by this same power supply which is distributed by a network of copper wiring throughout the structure. Conventional systems switch fixture power on and off at a location separate from the fixture. This separate location is typically on a wall near an entryway for the room in which the fixture is located.

LED (Light Emitting Diode) lighting is now becoming readily available as a lighting option for both commercial and residential applications. LED fixtures are typically uni-directionally driven. That is, LED fixtures are typically powered by a DC power source. In some instances, in a building structure for example, AC to DC power converters are provided on the fixture. AC power is supplied to the converter through the normal, legacy electrical wiring network. The converter converts the AC power to DC power in order to drive the LED load.

A typical lighting system, having conventional incandescent bulbs or LED lights, is controlled by one or more switches. For example, a room having light fixtures may have one or more wall switches that turn the lights on or off. Some intelligent switch systems are known. For example, known switching systems may provide a touch pad switch in place of a mechanical light switch. The touch pad may be used to turn lights off and on, dim lights, set lights to turn off or on at specified times, and to provide a remote interface for control of lighting either through a remote control device or through a communications network such as the Internet. In these scenarios, the actual power limiting function is physically located at the wall control—not at the fixture.

In a typical electrical device network, other electrical devices besides lights may be provided. For example, some common electrical devices for commercial and residential structures are fans, smoke detectors, carbon dioxide detectors, alarms, remote control units, speakers, motion sensors, light sensors, and the like. Typically, some of these devices are powered by AC power and are switched on and off by way of conventional wall switches. Some devices (e.g., fans) may be switched on and off at the wall switch and at a switch that is integral to the fan fixture. Some devices (e.g., smoke detectors) receive constant AC power through dedicated wiring. Again, in typical electrical device networks, the physical power switching function is located remotely from the fixture and at a switch device, which is commonly located on a wall near a doorway.

### SUMMARY

Currently, legacy lighting systems do not support multiple electrical fixtures or fixtures having multiple electrical devices. Viewed another way, electrical fixtures having multiple electrical devices are not always adapted to take full advantage of a legacy electrical wiring system. In at least some embodiments, an electrical system has one or more electrical fixtures. Each fixture may have multiple electrical devices. Continuous electrical power, such as AC power from a legacy electrical system, is supplied to each electrical fixture. Some devices within the fixture are directly powered by the continuous AC power supply. Other devices within the fixture are not operated continuously. Whether those devices receive power may be controlled by an intelligent controller. The intelligent controller may be disposed in any location in which it may communicate with the existing electrical network. The intelligent controller provides communication with the fixtures and/or with the devices that are part of the fixtures. While the intelligent controller may be used, for example, to send a signal to a device that it should turn on or off (for example), power to the fixture and/or device is not, in fact, turned on or off at the intelligent controller. Rather, for devices that do not operate continuously, power for the device may be physically turned on or off at the fixture.

In one example embodiment, for example, an intelligent electrical system includes a controller and an electrical fixture in communication with the controller. The electrical fixture is adapted to receive a continuous power supply. The electrical fixture has at least one continuously powered electrical device, and at least one switched electrical device. The controller is adapted to send one or more electronic signals to the electrical fixture to control delivery of power to, and operation of, at least switched electrical device associated with the electrical fixture.

In another example embodiment, an intelligent electrical system includes an electrical fixture adapted to receive a continuous power supply. The electrical fixture includes at least one electrical device. The system also includes a controller in communication with the electrical fixture. The controller is remote from the electrical fixture and is adapted to send one or more electronic signals to the electrical fixture to control delivery of power to, and operation of, the at least one electrical device. Physical control of power for the electrical fixture occurs at the electrical fixture.

In another example embodiment, a method of installing an intelligent electrical system is provided. One step is identifying a legacy electrical system having at least one legacy wall switch and at least one legacy electrical fixture. Another step is replacing the legacy electrical fixture with an intelligent electrical fixture. Another step is replacing the legacy wall switch with an intelligent controller. Another step is bypassing the legacy switch connection to establish continuous power to the intelligent electrical fixture. Another step is establishing signal communication between the intelligent controller and the intelligent electrical fixture to control physical switching of power at the intelligent electrical fixture.

Some, none, or all of the various embodiments may provide some, none, or all of the following advantages. One advantage is that legacy power systems may be used to provide power to intelligent electrical fixtures. Another advantage is that legacy power systems may be used to communicate control signals from intelligent control units to intelligent electrical fixtures to control one or more devices that are part of the respective fixture. Another advantage is that an electrical system may include fixtures having multiple electrical devices, where some of the devices may be operated continuously and some of the devices may have supply power turned on or off (or otherwise controlled). Another advantage is that a legacy electrical system may be easily converted to an intelligent electrical system having communication of control signals delivered from an intelligent controller, while having constant power delivered to intelligent fixtures.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of an intelligent electrical system according to an example embodiment;

FIG. 2 is block diagram of an intelligent electrical fixture according to an example embodiment;

FIG. 3 is a block diagram of an intelligent electrical system having an intelligent controller and an intelligent electrical fixture according to an example embodiment;

FIG. 4 is a block diagram of an intelligent electrical system having multiple intelligent controllers, intelligent electrical fixtures, and intelligent ports in communication with one another according to an example embodiment;

FIG. 5 is a block diagram of an intelligent controller according to an example embodiment;

FIG. 6 is a block diagram of an intelligent electrical port according to an example embodiment;

FIG. 7 is a block diagram of an intelligent port according to an example embodiment;

FIG. 8 is a diagram of a multi-array lighting system according to an example embodiment;

FIG. 9 is a diagram illustrating the adaptation of an intelligent electrical system to an existing electrical network according to an example embodiment; and

FIG. 10 is a perspective view of a modular intelligent electrical fixture according to an example embodiment.

### DETAILED DESCRIPTION

Among other things, various embodiments of the present invention provide intelligent electrical and lighting systems. These systems, in at least certain embodiment, may utilize existing electrical wiring and distribution networks within the respective commercial or residential structure. In one or more embodiments an electrical system may be provided that includes one or more intelligent electrical fixtures and one or more intelligent controllers. A respective fixture may include multiple electrical devices. One or more of the electrical devices may be continuously powered, for example, by the legacy power supply system. One or more other electrical devices may be controlled to be switched on or off, or otherwise have their respective power supplies controlled. Control of the fixture and/or its devices may be accomplished by signals being sent from the one or more intelligent controllers and received by the one or more intelligent fixtures. The signals may be sent, for example, over the legacy electrical network.

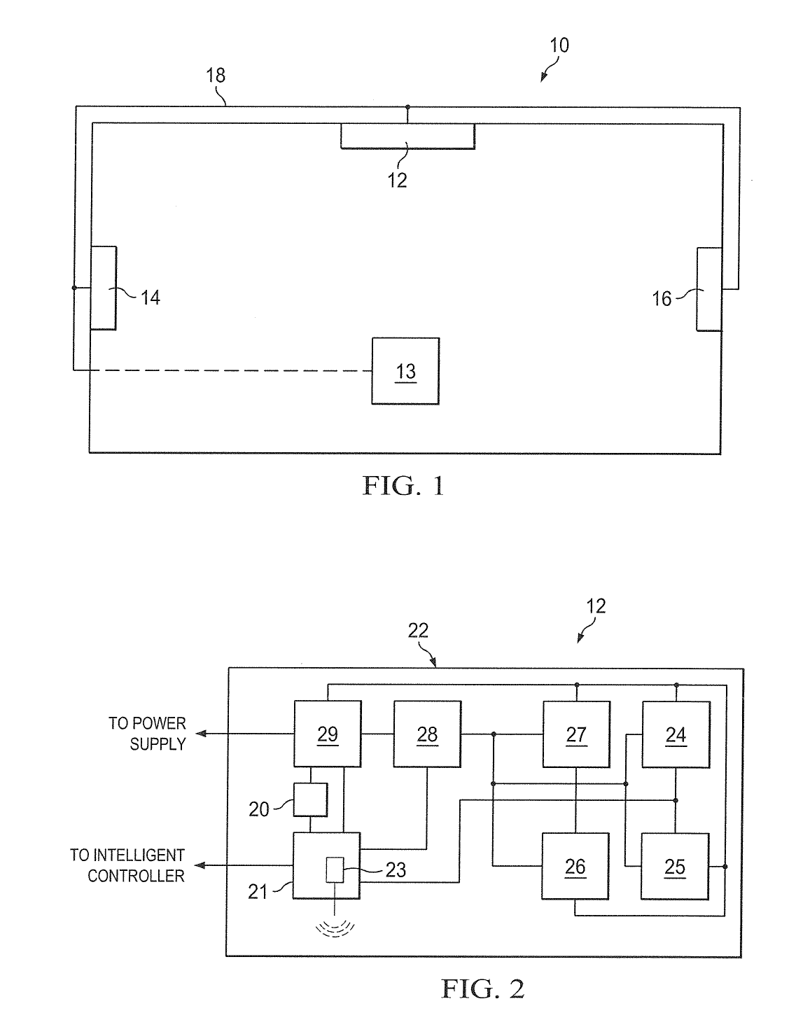

As shown in FIG. 1, for example, an intelligent electrical system 10 includes an intelligent electrical fixture 12, an intelligent port 13, a primary intelligent controller 14, and a secondary intelligent controller 16. The intelligent electrical network may be provided within in a structure, on an exterior of the structure, or in any other suitable context, such as an outdoor or mobile environment. The intelligent electrical network 10 may include an electrical wiring network 18, which may be provided, for example, within the walls of a commercial or residential building structure. The electrical wiring network may be one that is installed with the electrical system, or it may be a legacy electrical wiring network. In at least some embodiments, the electrical wiring network distributes power that is supplied to the structure. Therefore, in some instances in the United States, for example, the electrical wiring network distributes 60 Hz/100V AC power to the rest of the electrical system and to loads (e.g., intelligent fixtures) on the system.

Although only one intelligent electrical fixture is illustrated, it should be understood that intelligent electrical system 10 may include a plurality of intelligent electrical fixtures. Also, multiple intelligent ports may be provided. Further, the intelligent ports may also be referred to as intelligent fixtures. One or more intelligent ports may also be included as components of an intelligent fixture in addition to the other intelligent fixture components described herein. Further, although FIG. 1 illustrates a single primary intelligent controller and a single secondary intelligent controller, it should be understood that the system may include one, two, or more than two intelligent controllers. Further, intelligent controllers, intelligent fixtures, and intelligent ports may communicate with each other in any suitable configuration.

Intelligent electrical fixture 12 may be powered by way of electrical network 18. Signals to and from intelligent electrical fixture 12 may be received and/or transmitted through electrical wiring network 18. Alternatively, signals may be communicated wirelessly through any suitable wireless network. Signals to and from intelligent electrical fixture 12 may be transmitted to, or received from, for example, either or both of primary intelligent controller 14 and secondary intelligent controller 16.

In at least some embodiments, intelligent components receiving electrical power, such as intelligent electrical fixture 12 and intelligent port 13, receive a continuous power supply. That is, the power to these components is not physically switched, or switchable, from a remote location, as with a conventional electrical system. In these embodiments, in certain cases, power is constant, meaning it is supplied to intelligent component at a constant level. In some examples, the power is continuous, AC power. In other examples, the power may be continuous, DC power. Other types of power supplies may be utilized. The AC, DC, or other type of power supply may be constant or variable while still not being physically switched or physically controlled at a location remote from the intelligent electrical component.

As shown in greater detail in FIG. 2, intelligent electrical fixture 12 may have a housing 22 to support a number of various components. The components may include, for example, one or more loads 24, 25, 26, and 27. These loads may be any suitable electrical loads. In one example embodiment, load 24 is an incandescent light, load 25 is an LED light, load 26 is a fan, and load 27 is a smoke detector. It should be understood that the number, type and configuration of loads illustrated is for example purposes only. Any number of loads may be utilized, subject only to such constraints as size, spacing, maximum electrical load, building codes and the like. The loads may be configured in any suitable manner. Load types may include any type of lighting loads such as fluorescent bulbs, incandescent bulbs. LED lights and the like. The loads may also include other electrical devices such as fans, detectors, sensors, and outlets. Detectors may be of any suitable type including, for example, smoke detectors and carbon monoxide detectors. The sensors may be of any suitable type including, for example, motion sensors, sound sensors, and light sensors. Other electrical devices may be incorporated as necessary or desired (e.g., audio and video sub-functions).

Intelligent lighting fixture 12 may also include a power receiving and distribution module 29, which may be coupled to, for example, the power supply and/or the electrical wiring network of the structure. Module 29 may also be coupled to one or more loads. A power converter 28 is also provided and is in connection with power receiving and distribution module 29. Converter 28 is also coupled to one or more of the loads. Power converter 28 is adapted to convert power supplied to fixture 12 (either directly or by way of module 29) from one type to a second type suitable for driving one or more particular loads. In one example, converter 28 converts AC power to DC power. In other instances, power converter 28 may be adapted to convert power and switch the power on or off (or to another state), for delivery to and operation of, one or more electrical devices.

In the illustrated example, both module 29 and converter 28 are coupled to all of the loads. However, it should be understood that some of the couplings might not be utilized. For example, if a load receives power from an alternate source, such as power converter 28, then the coupling from module 29 might not be utilized. It should also be understood that, depending on the load and the power source required to drive it, various electrical couplings between one or more of the loads, power receiving and distribution module 29, and power converter 28, might not be provided.

A control module 21 is also provided. Control module is adapted to receive and/or transmit control and/or data signals for control of the various components of fixture 12, including loads 24, 25, 26, and 27. Some signals may be sent, by way of the electrical wiring network for example. Other signals may be sent wirelessly. Signals may be sent to and from other components within fixture 12 or to power sources and controllers, such as intelligent controllers 14 and 16 shown in FIG. 1. A wireless transceiver 23 is provided for the transmission and receipt of wireless communication, data, and control signals. Transceiver 23 may transmit and receive signals to and from one or more intelligent controllers and to and from other components of fixture 12. Transceiver 23 may also be coupled to other components in any other suitable alternate way. For example, transceiver 23 may connect to a central network access point (e.g., wireless router), which distributes communication throughout all system components.

A remote controller 20 is also provided. Remote controller 20 may be connected to the electrical and/or communication network of the intelligent electrical system, thereby enabling communication among all or some of the system components from and/or through the remote controller.

In at least one embodiment, remote controller 20 is coupled to module 29 to receive power and/or to control the operation of module 29. Remote controller 20 is also coupled to control module 21 in order to control the operation of control module 21 and/or to receive signals from control module 21. Remote controller 20 may also be coupled to other components (not expressly shown) within fixture 12, such as, for example, loads 24, 25, 26, and 27. Remote controller 20 may provide a number of different functions. For example, remote controller 20 may receive commands from a corresponding remote control unit (not shown) to connect or disconnect power from a component of fixture 12, turn a component (e.g., a load) on or off, or control some other aspect of the functionality of fixture 12. In at least some embodiments, the remote controller is a hand-held connection to the control network tying the remote controller into one, some, or all intelligent controllers, fixtures and outlets and fixtures. It can include touch screen input, fixed button function, audio, and display capabilities. The remote controller may have these human interfaces contact the intelligent controllers, outlets or fixtures to change and/or monitor their various functions.

In general, intelligent controllers send signals to, and receive signals from, intelligent electrical fixtures (and also potentially from components external to the electrical system, such as, for example, communications networks, computing platforms, central control modules, and the Internet). These signals control the operation of sub-modules within the intelligent electrical fixture. As continuous power is provided to the intelligent electrical fixture, the physical act of switching fixture sub-modules, or other components, on or off (or to another state) resides remotely from the intelligent controller. In at least some embodiments, the act of switching occurs at, or within, the intelligent electrical fixture itself. In other alternate embodiments, particularly those with additional inventive aspects, physical switching may occur at other locations.

It should be understood that FIG. 2 illustrates but one example of the wiring and interconnections between components of an intelligent electrical system. In other example embodiments, fewer or more components might be provided as part of the system. Also, the various components may be interconnected in any number of ways as desired and depending upon a variety of factors, such as, for example, the power requirements of the respective components.

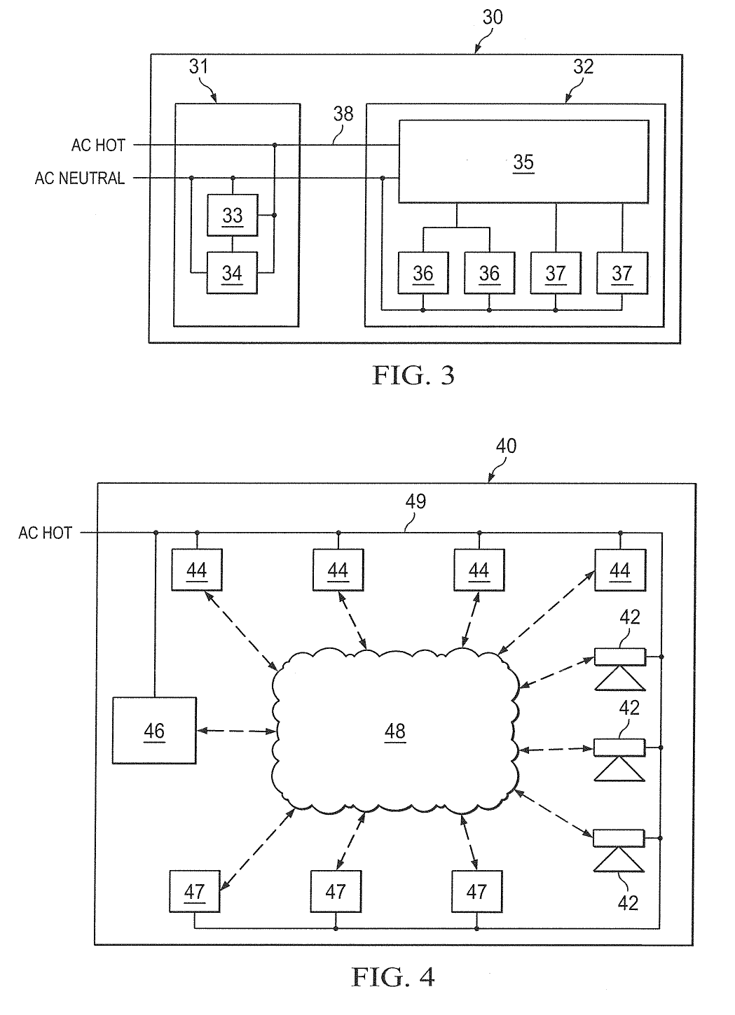

FIG. 3 is another example of electrical connections between various components of an intelligent electrical system. FIG. 3 also serves to illustrate the installation and/or establishment of an intelligent electrical system in the context of a legacy AC electrical system. As shown, an intelligent electrical system 30 includes a variety of components such as an intelligent controller 31 and an intelligent electrical fixture 32. Intelligent controller 31 includes a controller integrated circuit 33 and an interface 34. Intelligent electrical fixture includes a fixture integrated circuit 35, one or more constantly operating sub-functions 36 and one or more switched sub-functions 37. Intelligent controller 31 is electrically coupled to intelligent electrical fixture 32 by way of an electrical wiring network 38. Continuous power may be supplied to both intelligent controller 31 and to intelligent electrical fixture 32, as well as to the various components, subcomponents, and/or sub-functions of these elements.

FIG. 4 illustrates a communications network established among the various components of an example intelligent electrical system. As shown, intelligent electrical system 40 includes a plurality of intelligent electrical fixtures 42, a plurality of intelligent controllers 44 and a plurality of intelligent ports 47. A central control module 46 is also provided as is a communications network 48. Intelligent electrical fixtures 42, intelligent controllers 44, intelligent ports 47, and central control module 46 are all in communication by way of communications network 48 and by way of an AC electrical wiring network 49. Communication of signals may be executed between any of the various components of system 40. From any given component, communication signals may be sent to and/or received from a single other component or multiple components. Communication signals may be transmitted and received over communications network 48 and/or electrical wiring network 49. Communications over communications network 48 may be based on and/or provided over the Internet, Wi-Fi, radio, cellular, local area network, wide area network, or any other network or protocol as may be desired. Communication over the electrical wiring system may be provided by any suitable protocol, such as, for example, Universal Powerline Bus (UPB).

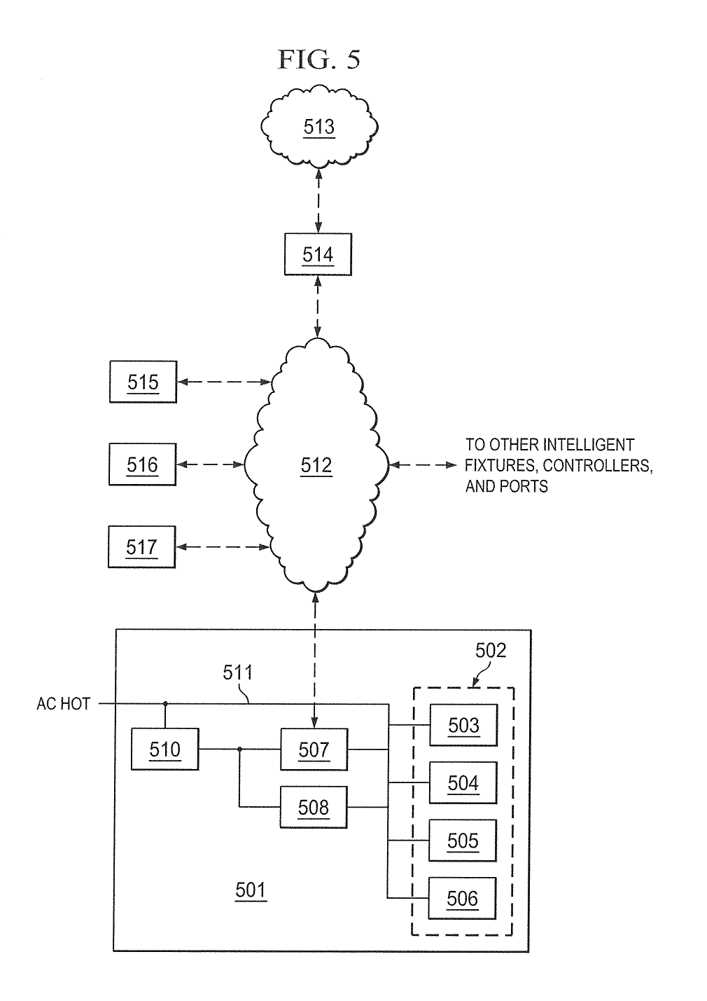

FIG. 5 illustrates an example of an intelligent controller and its interaction with various other components of an intelligent electrical system. Intelligent controller 501 includes an interface module 502. Interface module 502 includes various sub-modules, such as, for example, a capacitive touch interface 503, a display interface 504, an audio interface 505, and a sensor interface 506. Intelligent controller 501 also includes a communication module 507 and a control module 508. Also included in intelligent controller 501 is a power conversion module 510. The various components, modules, sub-modules, functions, and sub-functions of the intelligent controller may be interconnected by an electrical wiring network. This network may operate according to any suitable power scheme. In at least one example embodiment, the electrical network provides continuous AC power. Other components illustrated in FIG. 5 include Wi-Fi network 512, Internet 513, router, 514, central control unit 515, computer 516, and remote control unit 517.

Provisioning and control may be provided by any of, or a combination of, Internet 513, central control unit 515, computer 516, and remote control unit 517. Provisioning and control may be supplied to intelligent controller 501 from these components by way of router 514 and/or WIFI network 512. It should be understood that these are example components only and other networks and communications devices may be used in addition to these components, or in place of these components, as desired. Moreover, certain components are optional. For example, provisioning and control in some embodiments may be provided internally to intelligent controller 501 without the need, for instance, of an external central control unit or computer. In one alternative, provisioning and control is provided through a local interface (not expressly shown) exclusive to the individual intelligent controller. In another alternative example, the central control unit is a module or application provided on the computer. This module or application may, for example, couple the power line-based communication of other parts of the system to the computer. The central control unit may also be an off-the-shelf Wi-Fi unit or a stand-alone function with web-based control that ties directly to the Internet without the need for an external computer. The computer itself may be any suitable computing device including PCs, MACs, laptops, desktops, tablets, smart phones, and the like. In the illustrated example, provisioning and control are supplied to intelligent controller 501 through communication sub-function 507. From here, other components within intelligent controller 501 may receive provisioning and control either wirelessly (not expressly shown) or through some other network such as through electrical network 511. Provisioning and control refers to the delivery of any necessary communication signals, software, and the like necessary to provide the various functionality of the intelligent controller. Provisioning and control may include such functionality, for example, as “max on time,” “remote access,” and “timed turn off.” “Max on time,” in at least some embodiments, may mean the maximum time a function remains on after a particular event (e.g., such as a person leaving a room). “Remote access,” in at least some embodiments, may mean that the intelligent system permits access from a remote location (e.g., via the Internet) so that the functionality of intelligent components (e.g., controllers, outlets, and fixtures) may be modified. For example, lights may be turned on or off remotely. “Timed turn off” may refer to the functionality of intelligent components (e.g., lighting in an intelligent fixture) being activated at certain times. For example, lights might be set to turn on at a certain time in the morning and turn off at a certain time at night. Other provisioning might include assigning certain intelligent controllers to turn on certain electrical devices with their main touch screen button or even to reconfigure the display screen on a Controller to allow its main touch screen buttons to turn on specific fixtures or outlets. These are examples of provisioning and it will be understood that provisioning may include altering configuration of individual system components, as well as altering the functionality of components according to any suitable criteria.

While the illustrated example shows communication with, and internally to, the intelligent controller by way of electrical wiring, communication may also be accomplished by other means, such as a wireless communication network (not expressly shown).

Power conversion module 510 receives power from a supply (not shown). The power may be of any suitable source, type, etc. Power (e.g., from the power conversion module) may be continuous or switched. In the illustrated example, the power supplied is AC power. Power conversion module 510 may convert the AC power supply to any other power type, voltage, amperage, etc. necessary to drive the various components of the intelligent controller. Control module 508 provides for control of the various components of the intelligent controller and may host provisioning and control data. The interface module and its sub-modules provides for human control of the various components of the overall system (e.g., intelligent controllers, intelligent electrical fixtures, and intelligent ports). Power to the various components within intelligent controller 501 may be provided over electrical wiring network 511. Power may be delivered directly from the source or through the power conversion module. In either case, power delivered to a given component may be switched or continuous. Switching functionality may be provided as part of the intelligence of the intelligent controller, by way of an interface, as part of one or more internal switches (not shown), or by one or more switches (not shown) local to a given component.

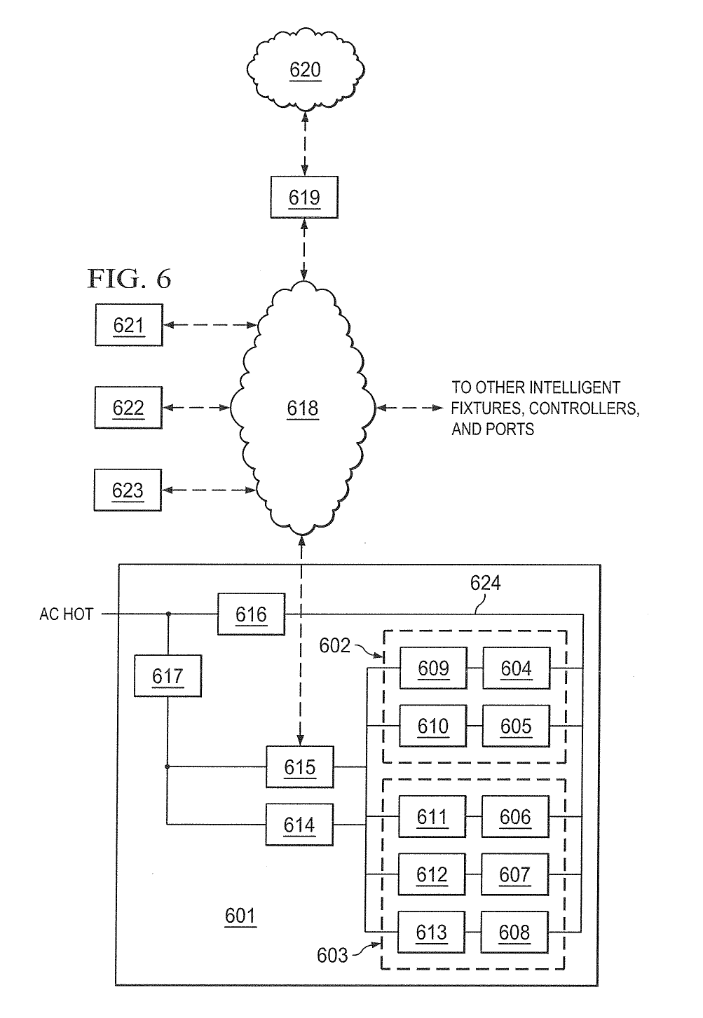

FIG. 6 illustrates an example of an intelligent electrical fixture. Intelligent electrical fixture 601 includes, for example, a power conversion module 617, which functions generally as described in connection with FIG. 5. Power conversion module 617 receives a power supply (AC power in this example) and converts it to the appropriate power supplies for the other components of intelligent electrical fixture 601.

Intelligent electrical fixture 601 also includes a communications module 615 that may communicate with other components of intelligent electrical fixture 601, other components within the intelligent electrical system (e.g., intelligent controllers, intelligent ports, and other intelligent electrical fixtures), and/or external components. The external components may include, for exam Internet 620, central control unit 621, computer 622, and remote control unit 623. Provisioning and control may be supplied to intelligent electrical fixture 601 from any, or a combination, of these components by way of router 619 and/or WIFI network 618. It should be understood that, as with the intelligent controller (an example of which is described in connection with FIG. 5), these components may include, or be replaced by, other suitable components, such as other types of networks, communication devices, controllers, and the like. Also, as with the intelligent controller, additional components may be provided. Provisioning and control may be supplied in a manner similar to that described in connection with the intelligent controller of FIG. 5.

Intelligent electrical fixture 601 also may include a mechanical override switch 616 for mechanically overriding the power supply to any of the components of intelligent electrical fixture 601. Power may be supplied to the components of intelligent electrical fixture 601 by way of electrical wiring network 624. Although one example wiring configuration is illustrated, it should be understood that power may be delivered to any of the various components, directly from the external power supply or indirectly through power conversion module 617. Also, it should be understood that even though certain elements are not shown as directly coupled to electrical wiring network 624, any component of intelligent electrical fixture 601 may be coupled to the electrical wiring network. For example, fan driver 609 (described below) is illustrated as being indirectly coupled to the electrical wiring network through a fan 604 (described below), which is directly coupled to the electrical wiring network. Alternatively, fan driver 609 may be directly coupled. This is true as well for the other components of intelligent electrical fixture 601.

Intelligent electrical fixture 601 also includes a control module 614, which functions in a manner substantially the same as control module 508 described in connection with FIG. 5.

Intelligent electrical fixture 601 includes a switched module 602 and a continuously operating module 603. In at least some embodiments, power for a given module may be delivered to a central hub from which it may be delivered to sub-modules within the particular module. Other alternate configurations, however, may be incorporated. Continuously operating module 603 includes a number of sub-modules that are operated continuously. These sub-modules receive a continuous power supply, such that they are, generally, not switched off. The continuously operating sub-modules may include any suitable sub-modules or functions. In the illustrated example, the continuously operating sub-modules include an audio sub-module, a sensor sub-module, and a detector sub-module.

The audio sub-module includes audio interface 611 and microphone 606. Other components not expressly shown (audio input/output, speakers, etc.) may also be included. The audio sub-module is preferably adapted to receive and process audio input, such as voice commands, for providing instructions to other components of the intelligent electrical fixture. It should be understood that audio interface 611 and microphone 606 may be replaced with other similar components in order to provide the same, or similar, functionality. It should also be understood that processing may occur at any suitable location, such as, for example, in a control module.

In the illustrated example, the sensor sub-module includes a sensor interface 612 and sensor 607. The sensor sub-module is preferably adapted to receive and process signals sensed by the sensor in order to provide instructions to the other components based on the sensed signals. Alternatively, sensor interface 612 conditions a signal to send it to another component (e.g., control module 614). The sensor may sense one or more conditions, which may include, for example, temperature, movement, light, and the like. The sensor interface is preferably adapted to process a sensed signal and, based on the sensed signal, determine whether an action should be initiated. Actions might include sending a message to another internal component, external component, or intelligent controller. Actions might also include turning on or off (or setting some other state for) another sub-module (e.g., a light or a fan). Sensor sub-modules and other sub-modules (e.g., the detector sub-module described below) may also be used as the detection point for initiating an alarm.

In the illustrated example, the detector sub-module includes detector interface 613 and detector 608. The detector sub-module is preferably adapted to detect and process information relating to one or more conditions. Detector 608 may be a smoke detector, carbon monoxide detector, or any other type of detector that detects a condition. In this regard, the detector sub-module functions much like the sensor sub-module. Generally, however, the detector sub-module does not provide input to other components. Thus, a smoke detector sub-module, for example, might be adapted to detect smoke, process a signal associated with the detection of smoke and activate an alarm in the smoke detector itself. It should be recognized, however, that certain exceptions may apply. For instance, the smoke detector sub-module might send a signal to turn on another component (e.g., emergency lighting) or turn off another component (e.g., a ventilation fan). It should be further recognized that these sub-modules are examples only. Other sub-modules continuously operated may be included. And, multiples of any particular sub-modules may be provided.

Switched module 602 includes a number of sub-modules that are may be switched on, off, or to some other operating state. These sub-modules may receive a continuous power supply, but be subject to local switching. Alternatively, these components may receive a switched power supply. The switched power supply may be controlled by control 614 and or other control units such as an intelligent controller and/or a central control unit. The switched sub-modules may include any suitable sub-modules or functions. In the illustrated example, the switched sub-modules include a lighting sub-module and a fan sub-module. In the illustrated example, the fan sub-module includes a fan driver interface 609 and a fan 604. The fan sub-module may be switched on or off (or to another state) locally or at another point in the intelligent electrical fixture (e.g., override 616 or control module 614), or at an intelligent controller. The fan sub-module may also be configured to send and receive signals to and from one or more other components in the intelligent electrical fixture or in another system component such as, for example, an intelligent controller. A “driver” (e.g., the fan driver), at least in some embodiments, receives power from the power source and functions as the point where the power may be switched on or off (or to another state) for the respective electrical device coupled to the driver.

In the illustrated example, the lighting sub-module includes a lighting driver interface 610 and a light 605. The lighting sub-module may be switched on or off (or to another state) locally or at another point in the intelligent electrical fixture (e.g., override 616 or control module 614), or at an intelligent controller. The lighting sub-module may also be configured to send and receive signals to and from one or more other components in the intelligent electrical fixture or in another system component such as, for example, an intelligent controller. The light 605 may be any suitable light fixture such as a conventional incandescent bulb, a fluorescent bulb, an LED or LED array.

Although the illustrated example only reflects one line of control as input to a particular sub-module, any given sub-module may have more than one control line input. For example, an LED light or LED array might have multiple control lines providing input from control module 614. This facilitates changing which LEDs are illuminated and to what amount. Thus, the system may control the spectral makeup of the LED to provide adjustments for human comfort, for example.

It should be noted that one or more of the described sub-modules may be included elsewhere in the electrical system. For example, the audio sub-module might be disposed in an intelligent controller rather than in an intelligent electrical fixture. It should also be noted that the configuration, number, and type of both the continuously operating sub-modules and the switched sub-modules may be varied as desired.

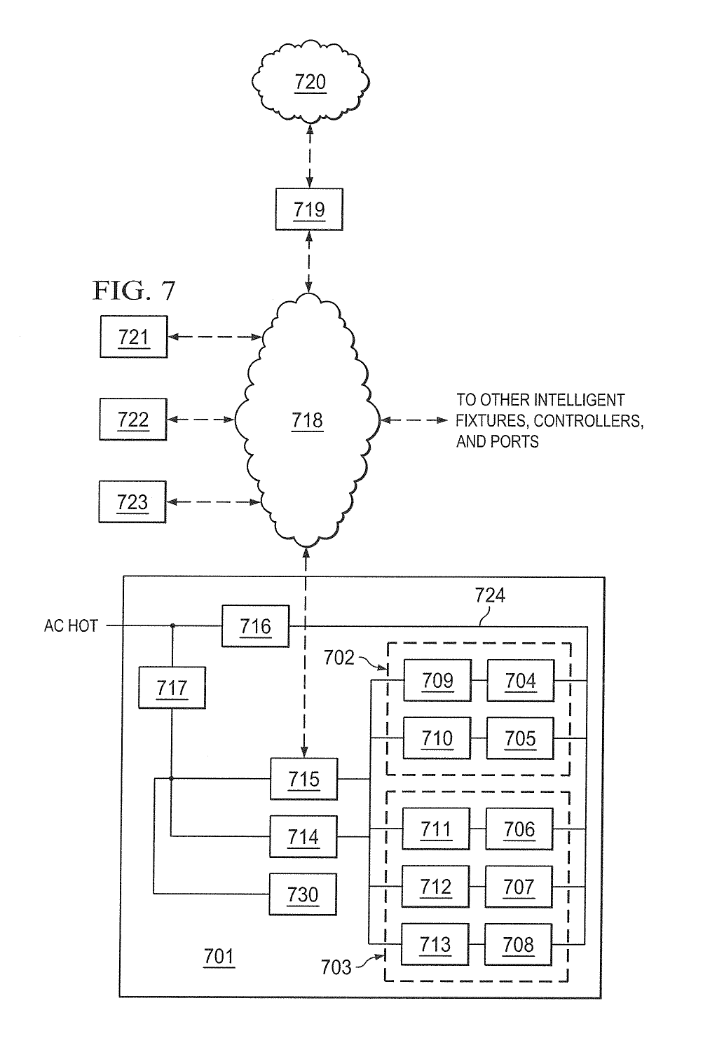

FIG. 7 illustrates an example intelligent port. The intelligent port may be viewed as a type of intelligent electrical fixture. In at least some embodiments, a port may be viewed as a receptacle for connecting an electrical device to electrical power and/or communications networks. For clarity's sake, however, it is described here as a separate component. Intelligent port 701 includes, for example, a power conversion module 717, which functions generally as described in connection with FIG. 5. Power conversion module 717 receives a power supply (AC power in this example) and converts it to the appropriate power supplies for the other components of intelligent port 701.

Intelligent port 701 may include a telecommunications connection, such as a voice and/or data connection. For example, a USB connection 730 (e.g., a USB Host Port). USB connection 730 enables a user to power a USB device (e.g., mobile phone). Power may be converted by module 717. In at least some embodiments, connection 730 is in electronic communication with other components such as, for example, communications module 715 and/or control module 714.

Intelligent port 701 also includes a communications module 715 that may communicate with other components of intelligent port 701 and/or external components. The external components may include, for example Internet 720, central control unit 721, computer 722, and remote control unit 723. Provisioning and control may be supplied to intelligent port 701 from any, or a combination, of these components by way of router 719 and/or WIFI network 718. It should be understood that, as with the intelligent controller (an example of which is described in connection with FIG. 5), these components may include, or be replaced by, other suitable components, such as other types of networks, communication devices, controllers, and the like. Also, as with the intelligent controller, additional components may be provided. Provisioning and control may be supplied in a manner similar to that described in connection with the intelligent controller of FIG. 5.

Intelligent port 701 also may include a mechanical override switch 716 for mechanically overriding the power supply to any of the components of intelligent port 701. Power may be supplied to the components of intelligent port 701 by way of electrical wiring network 724. Although one example wiring configuration is illustrated, it should be understood that power may be delivered to any of the various components, directly from the external power supply or indirectly through power conversion module 717. Also, it should be understood that even though certain elements are not shown as directly coupled to electrical wiring network 724, any component of intelligent port 701 may be coupled to the electrical wiring network.

Intelligent port 701 also includes a control module 714, which functions in a manner substantially the same as control module 508 described in connection with FIG. 5.

Intelligent port 701 includes a switched module 702 and a continuously operating module 703. Continuously operating module 703 includes one or more sub-modules that are operated continuously. These sub-modules receive a continuous power supply, such that they are, generally, not switched off. The continuously operating sub-modules may include any suitable sub-modules or functions. In the illustrated example, the continuously operating sub-modules include a first outlet sub-module, and audio sub-module, and a sensor sub-module.

The audio sub-module includes audio interface 711 and microphone 706. The audio sub-module is preferably adapted to receive and process audio input, such as voice commands, for providing instructions to other components of the intelligent outlet. It should be understood that audio interface 711 and microphone 706 may be replaced with other similar components in order to provide the same, or similar, functionality.

In the illustrated example, the sensor sub-module includes sensor interface 712 and sensor 707. The sensor sub-module is preferably adapted to receive and process signals sensed by the sensor in order to provide instructions to the other components based on the sensed signals. The sensor may sense one or more conditions, which may include, for example, temperature, movement, light, and the like. The sensor interface is preferably adapted to process a sensed signal and, based on the sensed signal, determine whether an action should be initiated. Actions might include sending a message to another internal component, external component, or intelligent controller. Actions might also include turning on or off (or setting some other state for) another sub-module (e.g., an outlet or a nightlight). Sensor sub-modules and other sub-modules may also be used as the detection point for initiating an alarm.

In the illustrated example, the first outlet sub-module includes first outlet interface 713 and first outlet 708. The first outlet sub-module is preferably adapted to provide continuous power devices plugged into first outlet 708. In some alternatives, it is unnecessary to have first outlet interface 713. In these cases, continuous power may be delivered directly to first outlet 708 without the need for additional signal processing. Other sub-modules that are continuously operated may be included. And, multiples of any particular sub-modules may be provided.

Switched module 702 includes a number of sub-modules that are may be switched on, off, or to some other operating state. These sub-modules may receive a continuous power supply, but be subject to local switching. Alternatively, these components may receive a switched power supply. The switched power supply may be controlled by control module 714 and or other control units such as an intelligent controller and/or a central control unit. The switched sub-modules may include any suitable sub-modules or functions. In the illustrated example, the switched sub-modules include a second outlet sub-module and a nightlight sub-module.

In the illustrated example, the second outlet sub-module includes a second outlet interface 709 and a second outlet 704. The second outlet sub-module may be switched on or off (or to another state) locally or at another point in the intelligent electrical fixture (e.g., override 716 or control module 714), or at an intelligent controller. The second outlet sub-module may also be configured to send and receive signals to and from one or more other components in the intelligent electrical fixture or in another system component such as, for example, an intelligent controller.

In the illustrated example, the nightlight sub-module includes a nightlight driver interface 710 and a nightlight 705. The nightlight sub-module may be switched on or off (or to another state) locally or at another point in the intelligent electrical fixture (e.g., override 716 or control module 714), or at an intelligent controller. The nightlight sub-module may also be configured to send and receive signals to and from one or more other components in the intelligent electrical fixture or in another system component such as, for example, an intelligent controller. The nightlight 605 may be any suitable light fixture such as a conventional incandescent bulb, a fluorescent bulb, an LED or LED array. Other lighting features as previously described may be applied to nightlight 605 as suitable and/or as desired.

It should be noted that one or more of the described sub-modules may be included elsewhere in the electrical system. For example, the audio sub-module might be disposed in an intelligent controller rather than in an intelligent electrical fixture. It should also be noted that the configuration, number, and type of both the continuously operating sub-modules and the switched sub-modules may be varied as desired.

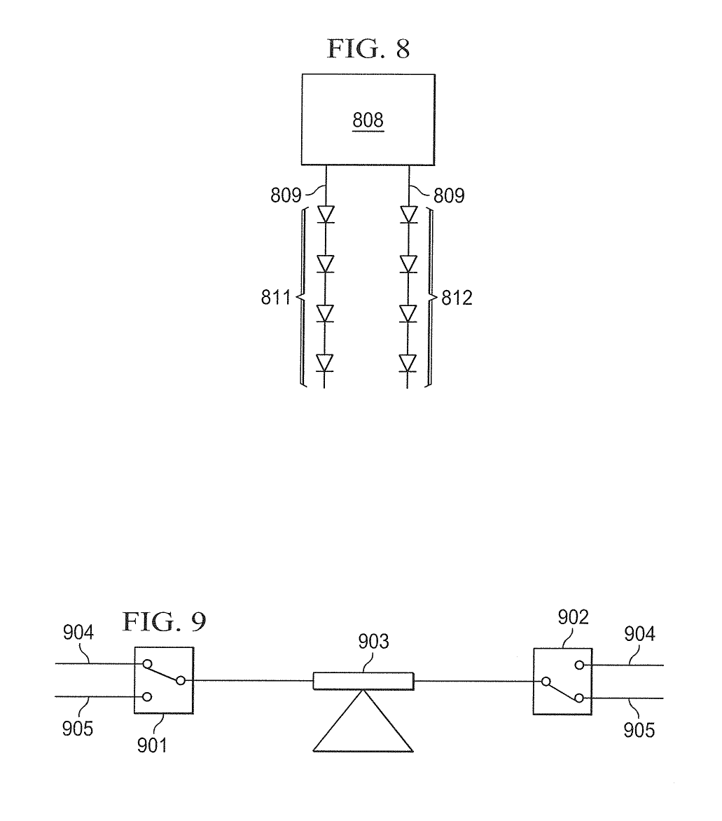

FIG. 8 illustrates a spectral lighting control concept that may be incorporated into, for example, an intelligent electrical fixture. Control module 808 may function similarly to control module 614 of the intelligent electrical fixture illustrated in FIG. 6. A first LED array 811 and a second LED array 812 are provided and coupled to control module 808 by way of LED control lines 809. Although not required, the LED arrays may be part of an intelligent electrical fixture as the other sub-modules previously described in connection with an intelligent electrical fixture.

In the illustrated example, there are two arrays of four LEDs each. It should be understood that there may be more than two arrays, and that each array may have fewer or more than four LEDs. First array 811 has a first spectral lighting content and second array 812 has a second spectral lighting content different from the first spectral light content. The control module manipulates power to the first and second LED arrays to vary an overall spectral lighting output.

FIG. 9 illustrates a dual light conversion concept within the context of an intelligent electrical system. First legacy switch 901 has an AC-hot lead 904 and an AC-neutral lead 905. Second legacy switch 902 similarly has an AC-hot lead 904 and an AC-neutral lead 905. Intelligent device 903 (e.g., an intelligent fixture or an intelligent port) has a hot lead connected to the AC-hot lead 904 of first legacy switch 901. Intelligent device 903 has a neutral lead connected to AC-neutral lead 905 of second legacy switch 902. This provides constant AC power to intelligent device 903. In other words, there is no physical power limiting (e.g., switching function) for intelligent device 903 provided, for example, remotely from intelligent device 903.

In at least one embodiment, an intelligent electrical system is installed on a legacy electrical platform. The method includes a first step of installing at least one intelligent electrical fixture. In a second step, the intelligent electrical fixture is coupled to a legacy AC electrical network bypassing at least one legacy switch in order to deliver constant AC power to the intelligent electrical fixture. In a third step, an intelligent controller is installed and connected to the intelligent electrical fixture. The connection may be established by way of the legacy AC electrical system. Alternatively, the connection may be established by way of a new electrical network or by a wireless connection. The intelligent controller may be installed at the location of a legacy switch. In a fourth step, an intelligent port is installed and connected to the intelligent controller. The intelligent port may be installed, for example, at the location of a legacy outlet. It should be understood that components of the intelligent electrical system may be installed at the location of similar components of a legacy system or at new locations. It should also be understood that one, two or more, of each type of component intelligent controller, intelligent port, and/or intelligent electrical fixture) may be provided. Intelligent fixtures and ports are connected to the legacy electrical wiring in a way to ensure that continuous power is supplied to the fixture or port.

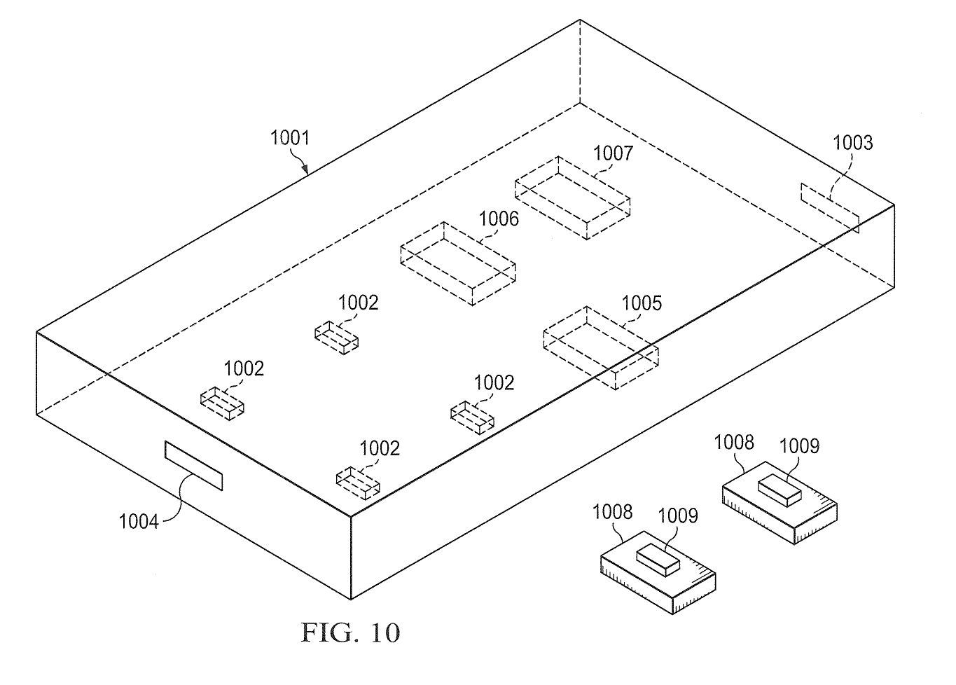

FIG. 10 illustrated a modular electrical fixture which may be used in the intelligent electrical system described herein. The fixture shown in FIG. 10 may be manifested in any of the intelligent components described herein (e.g., intelligent controllers, intelligent ports, and intelligent fixtures). The modular fixture 1001 has a housing, incorporated into which is one or more receiving sockets 1002 for receiving one or more electrical devices associated with the modular fixture (or controller or port).

While receiving sockets 1002 are illustrated as being rectangular in shape, it should be recognized that any shape will suffice as long as it is compatible with a corresponding connecting portion on a device being inserted into, or connected to, the receiving socket. Further, although four receiving sockets are shown, it should be recognized that the number of receiving sockets may be fewer than, or greater than, four. Also, the particular configuration and placement of the receiving sockets as illustrated is for example purposes only. Similarly, the shape and configuration of the modular fixture and its other components are for example purposes only. It should also be understood that one or more receiving sockets may be grouped (physically and/or electrically) into one or more continuously operating modules as previously described. Similarly, one or more receiving sockets may be grouped (physically and/or electrically) into one or more switched modules as previously described.

Modular fixture 1001 also has a power conversion module 1005, a communications module 1006 and a control module 1007. These are example components only and not necessarily required in all circumstances. It should similarly be recognized that other components as described herein in connection with controllers, ports and fixtures may be included in the modular fixture. These components function as generally described elsewhere herein.

Modular fixture 1001 is adapted to receive one or more modular electrical devices 1008. These devices may be any of those as previously described herein. Devices 1008 each have a connecting portion 1009 corresponding to, and adapted to be inserted into and connected to, receiving sockets 1002.

Modular fixture 1001 also has positive power coupler 1003 and negative power coupler 1004 for connecting modular fixture 1001 to an electrical wiring network. It should be understood that power may be supplied to modular fixture 1001 and its components according to any suitable configuration including, but not limited to, the various examples described elsewhere herein.

Although the present disclosure has been described with an exemplary embodiment, various changes and modifications may be suggested to one skilled in the art. For example, many of the sub-components (e.g.e, drivers, audio, sensors, detectors, electrical devices, interfaces, etc) although shown as separate components may be included in a single device, as in, for example, an integrated microcontroller. It is intended that the present disclosure encompass such changes and modifications as fall within the scope of the appended claims.

1. An intelligent electrical system comprising:
a controller; and
an electrical fixture in communication with the controller, the electrical fixture adapted to receive a continuous power supply;
the electrical fixture having at least one continuously powered electrical device, and at least one switched electrical device;
the controller adapted to send one or more electronic signals to the electrical fixture to control delivery of power to, and operation of, at least switched electrical device associated with the electrical fixture.

2. The intelligent electrical system of claim 1, wherein physical control of power for the electrical fixture occurs at the electrical fixture.

3. The intelligent electrical system of claim 1, wherein physical control of power for the electrical fixture occurs within the electrical fixture.

4. The intelligent electrical system of claim 1, wherein the electrical fixture is an electrical port.

5. The intelligent electrical system of claim 1, the electrical fixture comprising at least one continuously powered module and at least one switched module;
the continuously powered module adapted to receive a continuous power supply and having at least one sub-module adapted to continuously power the at least one continuously powered electrical device;
the switched module having at least one sub-module adapted to provide switched power to the at least one switched electrical device.

6. The intelligent electrical system of claim 1, wherein the at least one electrical device is a fan.

7. The intelligent electrical system of claim 1, wherein the at least one electrical device is a light.

8. The intelligent electrical system of claim 1, wherein the at least one electrical device is a sensor.

9. The intelligent electrical system of claim 1, wherein the at least one electrical device is a detector.

10. The intelligent electrical system of claim 1, wherein the at least one electrical device is an electrical outlet.

11. The intelligent electrical system of claim 1, wherein the at least one electrical device is a telecommunications connection.

12. The intelligent electrical system of claim 1, the at least one electrical device comprising a plurality of electrical devices, at least one of the plurality of electrical devices being a continuously powered electrical device and at least one of the plurality of electrical devices being a switched electrical device.

13. The intelligent electrical system of claim 1, wherein the one or more electronic signals are delivered over an electrical power wiring network.

14. The intelligent electrical system of claim 1, wherein the one or more electronic signals are delivered over a wireless communications network.

15. The intelligent electrical system of claim 1, further comprising an electrical port adapted to receive a continuous power supply.

16. The intelligent electrical system of claim 15, the electrical port having at least one continuously powered electrical device and at least one switched electrical device, wherein physical control of power to the at least one switched electrical device of the electrical port occurs at the electrical port.

17. The intelligent electrical system of claim 1, wherein the electrical fixture is adapted to be powered by a legacy electrical power wiring network.

18. The intelligent electrical system of claim 17, the electrical fixture having a hot lead adapted to be connected to a corresponding hot lead of a first switch of a dual-switch, legacy electrical system, the electrical fixture having a neutral lead adapted to be connected to a corresponding neutral lead of a second switch of the dual-switch legacy electrical system.

19. An intelligent electrical system comprising:
an electrical fixture adapted to receive a continuous power supply, the electrical fixture comprising at least one electrical device; and
a controller in communication with the electrical fixture, the controller being remote from the electrical fixture and adapted to send one or more electronic signals to the electrical fixture to control delivery of power to, and operation of, the at least one electrical device,
wherein physical control of power for the electrical fixture occurs at the electrical fixture.

20. A method of installing an intelligent electrical system, comprising:
identifying a legacy electrical system having at least one legacy wall switch and at least one legacy electrical fixture;
replacing the legacy electrical fixture with an intelligent electrical fixture;
replacing the legacy wall switch with an intelligent controller;
bypassing the legacy switch connection to establish continuous power to the intelligent electrical fixture; and
establishing signal communication between the intelligent controller and the intelligent electrical fixture to control physical switching of power at the intelligent electrical fixture.
